(19) United States
(12) Patent Application Publication
(10) Pub. No.: US 2025/0251265 A1
(43) Pub. Date: Aug. 7, 2025

(54) DEVICE FOR MEASURING A FLUID

(71) Applicant: PIETRO FIORENTINI S.p.A., Arcugnano (VI) (IT)

(72) Inventors: Mario VIANELLO, Rosate (MI) (IT); Lorenzo MEMÈ, Rosate (MI) (IT); Matteo D'ANGELO, Rosate (MI) (IT); Sergio GUZZETTI, Rosate (MI) (IT); Claudio IMBOCCIOLI, Creazzo (VI) (IT)

(73) Assignee: PIETRO FIORENTINI S.p.A., Arcugnano (VI) (IT)

(21) Appl. No.: 18/855,667

(22) PCT Filed: May 3, 2023
(86) PCT No.: PCT/IB2023/054590

§ 371 Date: Oct. 10, 2024

(30) Foreign Application Priority Data
May 3, 2022 (IT) 102022000008975

(51) Int. Cl. G01F 1/66; G01F 1/667

(52) U.S. Cl. CPC G01F 1/662; G01F 1/667

(57) ABSTRACT

A duct for the passage of a fluid to be detected and/or measured, for use with an ultrasound device for measuring the fluid includes: first and second pieces entirely or mostly made of polymeric material, configured to be joined and fixed together to define a measuring channel. The first piece includes: a first port for the inlet or outlet of the fluid to be measured; a first opening in the first piece for passage of ultrasonic signals emitted/received by at least one first ultrasonic sensor mounted on the first piece; a first tubular portion provided with a first abutment edge. The second piece includes: a second port for outlet or entry of the fluid from/into the duct; a second opening therein for passage of ultrasonic signals emitted/received by at least one second ultrasonic sensor mounted on the second piece; and a second tubular portion provided with a second abutment edge.

### CROSS REFERENCE TO RELATED APPLICATIONS

This application is a § 371 U.S. National Phase of International Patent Application No. PCT/IB2023/054590, filed May 3, 2023, which claims priority of Italian Patent Application No. 102022000008975, filed May 3, 2022, the entire contents of all of which are incorporated by reference herein as if fully set forth.

### INVENTIVE FIELD

The present invention relates to a duct for the passage of a fluid to be measured, said duct being suitable for being used for/in an ultrasound device for measuring a fluid, preferably a gas.

The present invention also relates to an ultrasound device for measuring a fluid, preferably a gas, which is provided with said duct.

In particular, the device is of the type suitable for measuring one or more quantities relating to a fluid which passes through the passage conduit with which the device is provided, and more specifically, it is suitable for measuring at least the flow rate and/or flow of fluid which passes through this conduit. Preferably, said fluid is a gas or a mixture of gases and, for example, it can be natural gas or another gas produced in a decentralized way, such as biomethane and/or hydrogen.

Preferably, said device is suitable for use inside a gas meter and, in particular, a gas meter (also called “gas meter”).

Therefore, the invention finds advantageous use in the technical sector of the production and marketing of apparatus and devices for measuring fluids and can be advantageously used both at the domestic level and at the industrial level. Conveniently, the device according to the invention can be used for counting gas consumption in a domestic or industrial plant, or for counting gas consumption in general, for example when leaving a container.

### BACKGROUND

Various ultrasonic devices are currently known which can be installed inside a gas meter (also called “gas meter”) in order to measure the gas flow through the device itself.

Ultrasound devices of the known type, such as for example the one described and illustrated in JP2014215060, comprise a duct, with a substantially tubular development and a substantially rectangular cross section, for the passage of the gas to be measured. Furthermore, the duct of these devices has, in correspondence with the upper wall, an elongated insertion port (i.e. an open/missing portion) for the assembly and positioning inside the duct itself of a plurality of dividing plates which are made in a piece separate from the conduit and which are configured and arranged in such a way as to make uniform the distribution of the flow velocity of the fluid passing through the conduit. Once the partition plates have been inserted, the elongated insertion port is first covered with an entrainment flux suppression foil and then closed with a mounting block in which corresponding mounting seats are machined for a pair of ultrasonic sensors.

In particular, the two ultrasonic sensors, which are configured to emit and receive ultrasonic signals, are mounted at the top wall and are positioned one upstream and one downstream along the direction in which the fluid passes through the duct. In more detail, the ultrasonic signal emitted by one sensor is reflected from the internal surface of the wall, which is opposite to both sensors, towards the other sensor (and/or vice versa), thus allowing the ultrasonic signal to intercept the fluid flow which flows inside the duct thus defining a “V” reflection path.

In order to reduce the number of components which are made separately by molding, and therefore in order to reduce the corresponding costs, in particular of assembly, a solution has therefore already been proposed, such as the one illustrated in WO 2020/031621, WO 2020/031622 or WO 2020/044887, in which the conduit for the passage of the fluid to be measured is molded in one piece with the dividing plates and furthermore, in correspondence with the upper wall of the conduit, no elongated insertion ports are obtained, but are obtained two separate openings, each facing one of the two ultrasonic sensors, to thus allow the ultrasonic signals from the sensors to enter and exit said conduit.

The known solutions do not allow the reflection of the ultrasonic signals emitted by a sensor and received by the other sensor to be varied and optimized in a simple way, in particular in order to adapt to the composition of the fluid to be measured.

### OBJECTS OF THE INVENTION

The object of the invention is to propose a fluid passage duct to be used for/in an ultrasound device for measuring said fluid, preferably a gas, which allows to overcome, at least in part, the drawbacks present in the known solutions.

Another object of the invention is to propose an ultrasound device for measuring a fluid, preferably a gas, which allows the drawbacks present in the solutions of the prior art mentioned above to be overcome, at least in part.

Another object of the invention is to propose a duct and a device which allow to vary and optimize the reflection, particularly in terms of reflection path, of the ultrasonic signals towards the receiving ultrasonic sensor.

Another object of the invention is to propose a duct and a device which are fluid-tight, preferably gas-tight.

Another object of the invention is to propose a duct which can be easily and rapidly modified in terms of size and/or geometry.

Another object of the invention is to propose a conduit which can be easily and rapidly adapted to measure different fluids and/or quantities.

Another object of the invention is to propose a duct and a device which can be produced and assembled in series in a rapid and efficient manner.

Another object of the invention is to propose a conduit and a device which are structurally and functionally completely reliable.

Another object of the invention is to propose a duct and a device which are improvements and/or alternatives to the traditional ones.

Another object of the invention is to propose a conduit and a device which can be manufactured simply, rapidly and at low cost.

Another object of the invention is to propose a duct and a device which present an alternative characterization, both in constructive and functional terms, with respect to the traditional ones.

### SUMMARY

All the purposes mentioned here, considered both individually and in any combination thereof, and others which will result from the following description are achieved, according to the invention, with a duct as set forth in the appended claims.

### BRIEF DESCRIPTION OF THE DRAWINGS

The present invention is hereinafter further clarified in some of its preferred embodiments shown for purely exemplifying and non-limiting purposes with reference to the attached table of drawings, in which:

FIG. 1 shows a perspective view of the duct according to the invention in a first embodiment,

FIG. 2 is a side view of the duct of FIG. 1,

FIG. 3 is a partially sectioned perspective view of the first piece of the duct of FIG. 1,

FIG. 4 shows a section of the duct of FIG. 1 according to a plane extending along the X and Y directions and passing through the center of the duct itself, in a variant in which the mounting means for the electronic card are provided only on the first piece,

FIG. 5 shows in the same view of FIG. 3 a second embodiment of the duct according to the invention,

FIG. 6 shows a partially sectioned side view of the first piece of the duct of FIG. 5,

FIG. 7 shows in the same view of FIG. 3 a third embodiment of the duct according to the invention,

FIG. 8 is an exploded perspective view of the duct of FIG. 7,

FIG. 9 shows an exploded perspective view of the duct of FIG. 7 partially dissected,

FIG. 10 is a perspective view of the first piece of the duct of FIG. 7,

FIG. 11 is a perspective view of the second piece of the duct according to the invention which can be used in the duct of both FIG. 1 that of FIG. 7,

FIG. 12 is a partially sectioned perspective view of the second piece of FIG. 11, and

FIG. 13 shows a partially sectioned perspective view of a variant of the second piece of FIG. 11.

### DETAILED DESCRIPTION OF THE PREFERRED EMBODIMENTS

As can be seen from the figures, the present invention relates to a conduit 1 for the passage of a fluid to be detected/measured, preferably a gas but could also be a liquid, for example water. In particular, the conduit 1 is suitable to be used for/in an ultrasonic device for measuring the fluid. In particular, the device is of the type suitable for detecting the presence of a fluid and/or for measuring one or more quantities relating to the fluid flowing through the passage duct 1 with which the device is provided, and more specifically, it is suitable for measuring at least the flow rate and/or flow of fluid passing through said conduit. Preferably, said fluid to be detected/measured is a gas or a mixture of gases and, for example, it can be a natural gas or gas of other types produced in a decentralized way, such as biomethane or hydrogen.

Preferably, the device is suitable for use inside a gas meter and, in particular, a gas meter (also called “gas meter”).

The conduit 1 comprises two pieces, respectively a first piece 20 and a second piece 30, which are then fixed together to define, following their union and only in combination, a measuring channel 40 which is intended to be crossed by the fluid to measure. Preferably, the measuring channel 40 can be closed fluid-tight at least in correspondence with the areas of union/contact between the two pieces 20 and 30. Preferably, the measuring channel 40 can be entirely closed fluid-tight along its development longitudinal.

Conveniently, the measuring channel 40—which is defined by the joining and fixing of the second piece 30 to the first piece 20—has a longitudinal development along the X direction, which also corresponds to the main advancement direction of the fluid flow crossing the channel. Furthermore, the cross section of the measuring channel 40 is preferably of a substantially rectangular shape and develops along a Y direction and along a Z direction, perpendicular both to each other and to the X direction so as to thus complete the Cartesian triad, in which—preferably—the extension along the Y direction is greater than the extension along the Z direction. Advantageously, the substantially rectangular shape of the cross section of the measuring channel 40 allows to obtain a constant and more uniform speed of the fluid (compared for example to a circular section).

Suitably, the duct 1 comprises a first port 27′ for the inlet or outlet of the fluid to be measured in/from said duct 1 and a second outlet 27″ for the outlet or inlet of the fluid from/into said duct 1. Suitably, the first port 27′ is defined in the first piece 20, while the second port 27″ is defined in the second piece 30. The fluid to detect/measure can pass through the conduit 1—and in particular the measuring channel 40—with a direction of the flow F which mainly goes from the first port 27′ towards the second port 27″. Conveniently, the first mouth 27′ and the second mouth 27″ are aligned and facing each other. Conveniently, it is understood that the fluid flow could cross the conduit 1 in the opposite direction, ie be directed from the second port 27″ towards the first port 27′.

Conveniently, the two pieces 20 and 30—which, once they are fixed together, define the duct 1 and internally delimit the measuring channel 40—are made by molding. Conveniently, the two pieces 20 and 30 can be molded separately or together. Conveniently, the two pieces 20 and 30 can be molded by using a single suitable mold or with two distinct molds. Conveniently, the two pieces 20 and 30 can be extracted from the single mold already separated or they can be extracted still connected to each other (for example with a section of sprue), to be separated later.

Conveniently, the two pieces 20 and 30 are made entirely or mostly of polymeric material, preferably of thermoplastic material. The two pieces 20 and 30 can be made by molding with at least one polymeric resin, for example PolyButylene Terephthalate (PBT), Glycoluryl-Formaldehyde (GF), PolyPropylene (PP), PolyOxyMethylene (POM), PolyCarbonate, Acrylonitrile ButadieneStyrene (ABS), or even recycled plastic polymer materials.

Preferably, the two pieces 20 and 30 are made of the same thermoplastic material. Conveniently, in a possible embodiment, the second piece 30 can be made of a different thermoplastic material than the first piece 20.

Conveniently, to define the measuring channel 40, the two pieces 20 and 30 are fixed and kept together, at the respective abutting edges 28 and 38, by means of one or more technologies for joining plastic materials, such as in particular: gluing and/or welding (for example by laser, ultrasound, hot blade, rotational friction) and/or hot plastic riveting and/or by mechanical joining (for example with a shape/joint engagement and/or hooking and/or snap-fit and/or press-fit).

The first piece 20 comprises a first tubular portion 21 which extends along the longitudinal direction X and which, preferably, has a substantially rectangular cross-section, optionally with rounded corners.

The first tubular portion 21 comprises:
a first upper wall 22′,
a first bottom wall 22″ which faces the first top wall 22′,
two first side walls, respectively 23′ and 23″, arranged between the first upper wall 22′ and the first bottom wall 22″ so as to define a substantially rectangular cross-section.

Conveniently, the first two lateral walls 23′ and 23″ face each other along the Z direction, while the first upper wall 22′ and the first bottom wall 22″ face each other along the Y direction. Conveniently, the two side walls 23′ and 23″ extend between the first upper wall 22′ and the first bottom wall 22″ substantially along the direction Y which is perpendicular to the longitudinal direction X. Suitably, the first upper wall 22′ and the first bottom wall 22″ each extend between the first side walls 23′ and 23″ substantially along the Z direction.

Suitably, the first piece 20 also comprises the first mouth 27′ of the conduit 1 which, as mentioned, can define the inlet or outlet mouth of the fluid in/from the conduit 1. Advantageously, the first mouth 27′ can be defined at a end of the first tubular portion 21.

Conveniently, the first tubular portion 21 of the first piece 20 also comprises a first abutting edge 28 which is intended to come into contact, to then be joined and fixed, with a second abutting edge 38 of a second tubular portion 32 provided in the second piece 30, to thus define the measuring channel 40.

Conveniently, the first abutting edge 28 is formed on the first tubular portion 21 at an end longitudinally opposite to that at which the first mouth 27′ is defined.

Conveniently, the first abutting edge 28 is defined on all the walls 22′, 22″, 23′ and 23″ of the first tubular portion 21. Conveniently, the first abutting edge 28 of the first upper wall 22′ can be located in a more advanced position, along the X direction, with respect to the first abutment edge of the first back wall 22″. Conveniently, the abutting edge of the first side walls 23′, 23″ can be inclined or shaped.

Preferably, the first piece 20 also comprises at least one dividing plate 70 for the flow of fluid which is intended to cross said measuring channel 40, said at least one dividing plate 70 coming out of the first tubular portion 21 at the abutment edge 28.

Preferably, said at least one dividing plate 70 is made in one piece with the first piece 20 and in particular with the first tubular portion 21. Conveniently, said at least one dividing plate 70 extends, at least partially, inside the first tubular portion 21. Conveniently, the dividing plates 70 are configured so as to divide the inside of the measuring channel 40 obtained by joining and fixing the first piece 20 with the second piece 30 into two or more layers. Partition 70 inside the measuring channel 40 improves the measurement performance due to the greater perimeter of the layers into which said channel is divided by said at least one partition plate.

Preferably, the dividing plates 70 protrude from the first tubular portion 21, and in particular protrude beyond the first abutment edge 28 of the first tubular portion 21.

Advantageously, therefore, the first piece 20 comprises at least one dividing plate 70 of the flow F which is configured to be entirely inserted and housed inside the second piece 30, once the abutment edge 28 of the first piece 20 has come into contact with the abutment edge 38 of the second piece 30, thus defining the measuring channel 40.

Conveniently, the dividing plates 70 protrude from the first tubular portion 21 to then be fully inserted and housed inside a second tubular portion formed in the second piece 30, once the first abutment edge 28 of the first piece 20 comes into contact with the second abutting edge 38 of the second piece 30. Advantageously, this allows to facilitate and speed up the assembly of the two pieces since the dividing plates 70 protruding from the first piece 20 define a component of the “male” type which thus fits inside a component of the “female” type defined by the second piece 30.

Conveniently, the dividing plates 70 have a development along the X direction such that, when the first abutting edge 28 of the first piece 20 comes into contact with the second abutting edge 38 of the second piece 30, the aforementioned plates substantially affect the majority or the entire longitudinal development (i.e. along the X direction) of the measurement channel 40.

Conveniently, as mentioned, said at least one dividing plate 70 is molded in a single body with the first tubular portion 21 of the first piece 20.

Each dividing plate 70 has a substantially laminar development in which the extension along the Z direction (thickness) is much smaller than the extension along the other two directions X and Y. Conveniently, each dividing plate 70 is arranged, at least partially inside interior of the first tubular portion 21 so as to lie on a plane that extends along the two directions X and Y. Preferably each dividing plate can protrude from said first tubular portion 21 to be thus inserted and housed inside the second tubular portion 31 of the second piece 30. Conveniently, if several dividing plates 70 are provided, these are arranged so as to be spaced apart from each other and substantially parallel to each other along the direction Z.

Preferably, each dividing plate 70 can have a variable thickness along the X direction and, in particular, can have a maximum thickness in correspondence with a central portion thereof along the X direction, and also having a gradually decreasing thickness towards the first mouth 27′ of the first piece 20 and towards the second mouth 27″ of the second piece 30.

Preferably, the leading and/or trailing edges of each partition plate 70 can be curved, i.e. chamfered and rounded.

Conveniently, in a possible embodiment not shown here, it is the second piece 30 which comprises said at least one dividing plate 70 which protrudes from the second tubular portion 31 in correspondence with the abutment edge 38 and which is configured to be fully inserted and housed in the inside of the first piece 20, once the abutment edge 28 of the first piece 20 has come into contact with the abutment edge 38 of the second piece 30, thus defining the measuring channel 40.

Conveniently, in a possible embodiment not shown here, in addition to said at least one dividing plate 70 of the first piece 20, the second piece 30 also comprises at least one further dividing plate for the flow of fluid which is intended to pass through said measurement 40, said at least one further dividing plate protruding from the second tubular portion 31 in correspondence with the abutment edge 38 and is configured to be entirely inserted and housed inside the first piece 20, once the abutment edge 28 of the first piece 20 has come into contact with the abutment edge 38 of the second piece 30, thus defining the measuring channel 40. Preferably, the first mouth 27′ comprises a flanged edge 50. Preferably, at the first mouth 27′, the flanged edge 50 can join up with the first tubular portion 21 with a curved profile with outward concavity, thus defining a funnel-shaped portion (not shown). Preferably, the dividing plates 70 extend along the X direction until they arrive substantially flush with the first mouth 27′.

Suitably, the first piece 20 comprises a first opening 25 for the passage of ultrasonic signals 17 emitted and/or received by at least one first ultrasonic sensor 19′ which is mounted (or which is intended to be mounted) on said first piece 20. Preferably, the first opening 25 is obtained on the first upper wall 22′ of the tubular portion 21 of the first piece 20 and is configured so that the ultrasonic signals (waves) 17, emitted by at least one corresponding first ultrasonic sensor 19′, enter and/or come out of the measuring channel 40—which is obtained by joining and fixing the second piece 30 to the first piece 20—crossing said opening 25.

Conveniently, at the first opening 25, the duct 1 comprises a first mounting portion 24 for the first ultrasonic sensor 19′. Conveniently, the first mounting portion 24 comprises a corresponding first seat 26 which is configured to receive a corresponding ultrasonic sensor 19′. The first seat 26 communicates with the first opening 25 so that the ultrasonic signals 17 can enter the measuring channel 40 and/or leave it.

Conveniently, the first mounting portion 24—and in particular the respective first seat 26—is configured so that the ultrasonic signals 17 emitted by the first sensor 19′ enter and exit the measuring channel 40 at an angle with respect to the direction X, and in particular with respect to the main advancement direction of the fluid flow F inside the channel.

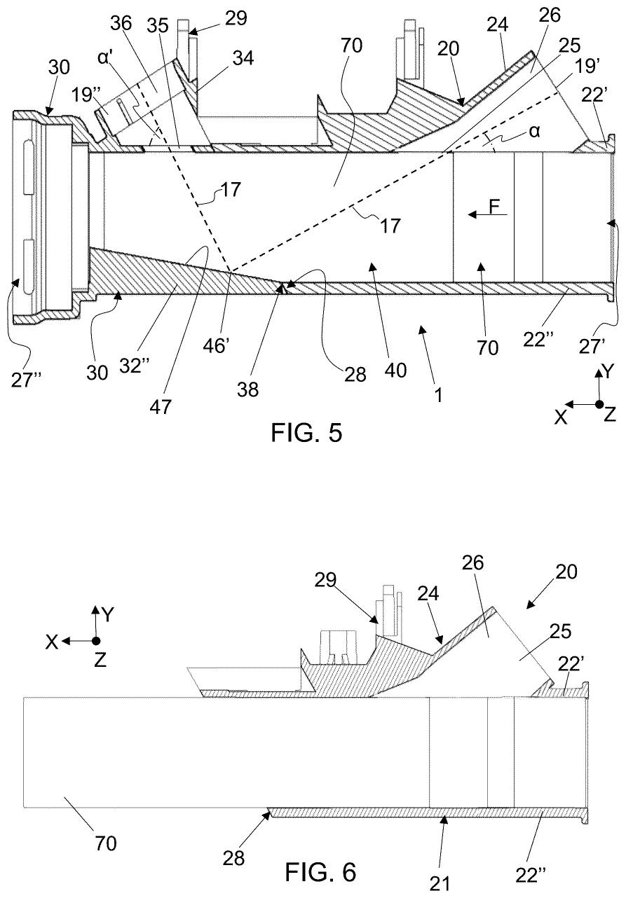

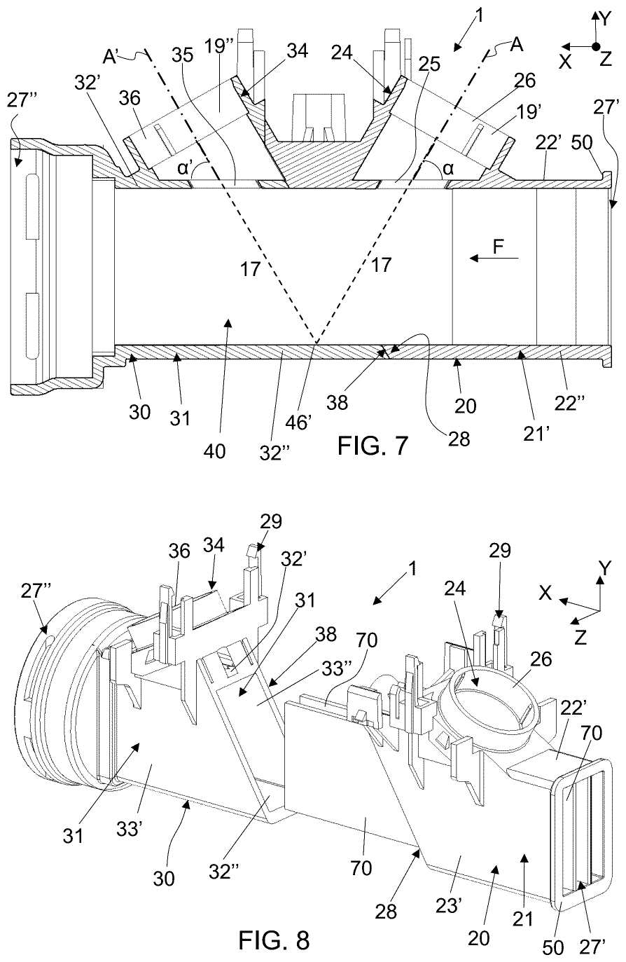

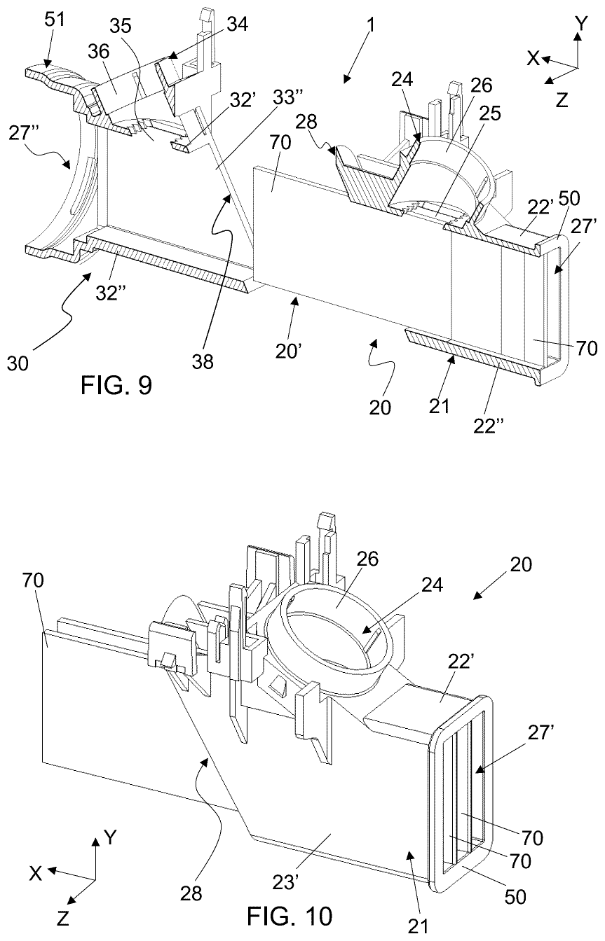

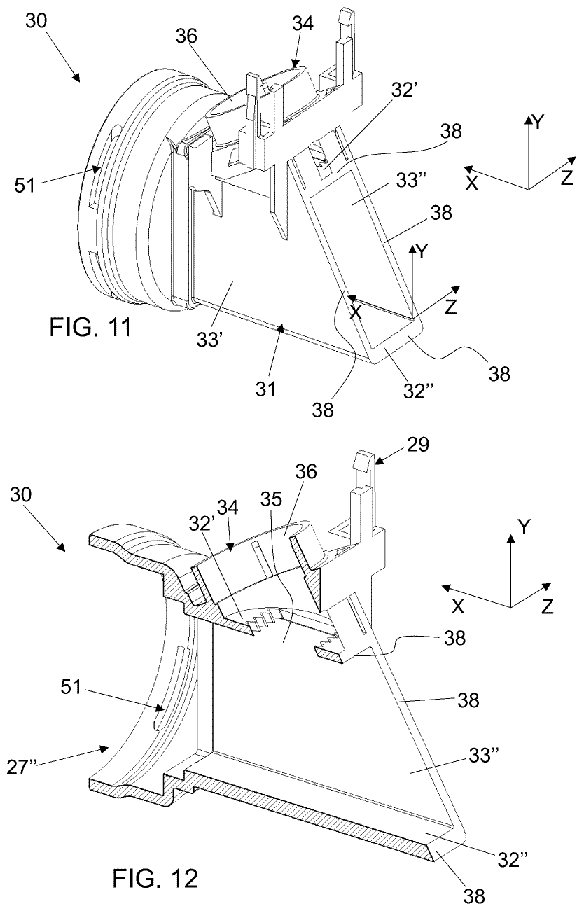

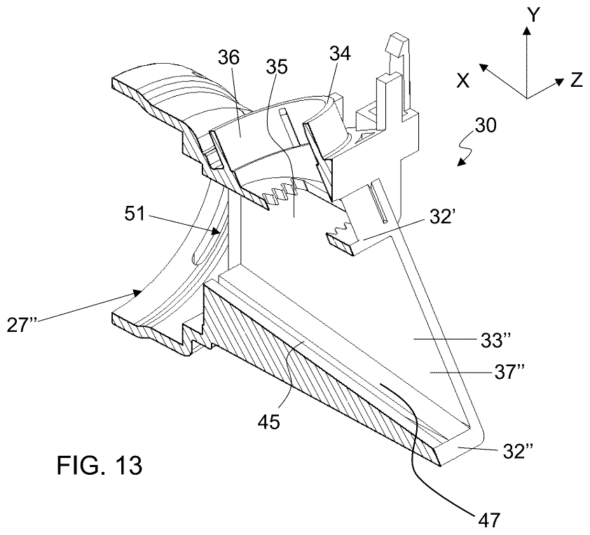

Conveniently, the longitudinal development axis A of the first mounting portion 24 is angled with respect to the X direction by a corresponding angle a lower than or equal to 90° so that the ultrasonic signal 17 emitted by the first sensor 19′ can define a path of “V” reflection, which can be symmetrical (see FIG. 7) or asymmetrical (see FIG. 5) or “W” (see FIG. 4), to then be received by the second mounted 19″ sensor on the second piece 30 (or vice versa), as described in more detail below.

Conveniently, in the case of a “W” reflection path (cf. FIG. 4), a first reflection zone 46′ is provided on the second back wall 32″ of the second piece 30, a second reflection zone 46″ which is defined on the first upper wall 22′ of the first piece alongside the first opening 25 of the first sensor 19′, and a third reflection zone 46″′ which is defined on the first bottom wall 22′ of the first piece 20.

Conveniently, in the case of a “V”-shaped reflection path (see FIG. 5), a first and only reflection zone 46′ is provided which is defined on the second bottom wall 32″ of the second piece 30.

Conveniently, in the embodiment shown, the first assembly portion 24 is made (molded) in a single piece with the first piece 20, however—in a possible embodiment not shown here—said portion could be made/molded in one or more separate pieces with respect to the first piece 20 and then be fixed to the latter by gluing or welding or by mechanical fixing.

The second piece 30 comprises a second tubular portion 31 which extends along the longitudinal direction X and which, preferably, has a substantially rectangular cross-section, optionally with rounded corners.

The second tubular portion 31 comprises:
a second upper wall 32′,
a second bottom wall 32″ which faces the second top wall 32′,
two second lateral walls, respectively 33′ and 33″, arranged between the second upper wall 32′ and the second bottom wall 32″ so as to define a substantially rectangular cross-section.

Conveniently, the two second side walls 33′ and 33″ face each other along the Z direction, while the second upper wall 32′ and the second bottom wall 32″ face each other along the Y direction. Conveniently, the two second side walls 33′ and 33″ extend between the second upper wall 32′ and the second bottom wall 32″ substantially along the direction Y which is perpendicular to the longitudinal direction X. Suitably, the second upper wall 32′ and the second bottom wall 32″ each extend between the second side walls 33′ and 33″ substantially along the Z direction.

Suitably, the second piece 20 also comprises the second mouth 27″ of the conduit 1 which, as mentioned, can define the inlet or outlet mouth of the fluid in/from the conduit 1. Advantageously, the second mouth 27′ can be defined at one end of the second tubular portion 31.

Conveniently, as mentioned, the second tubular portion 31 of the second piece 30 also comprises a second abutting edge 38 which is intended to come into contact, to then be joined and fixed, with the first abutting edge 28 of the first tubular portion 21 of the first piece 20, to thus define the measuring channel 40.

Conveniently, the second abutting edge 38 of the second piece 30 is configured so that its cross section (i.e. on the YZ plane) substantially corresponds in terms of shape and dimensions to the cross sectional profile of the first abutting edge 28 of the first piece 20 so that, once the two edges are in contact to be thus joined and fixed, they define a measuring channel 40 which is closed in a fluid-tight manner at least at the aforementioned joining/contact edges between the two pieces, thus avoiding that the fluid which passes through the two pieces comes out in correspondence with the areas where the two pieces 20 and 30 are in contact with each other.

Conveniently, the second abutting edge 38 is formed on the second tubular portion 31 at an end which is longitudinally opposite to that at which the second mouth 27′ is defined.

Suitably, the second abutting edge 28 is defined on/along all the walls 32′, 32″, 33′ and 33″ of the second tubular portion 31. Suitably, the second abutting edge of the second bottom wall 32″ it can be in a more advanced position, along the X direction, with respect to the second abutting edge of the second upper wall 32′. Conveniently, the abutting edge of the second side walls 33′, 33″ can be inclined.

Conveniently, the thickness of the second abutting edge 38 can have a variously shaped conformation which is complementary to the conformation of the first abutting edge 28.

Conveniently, the first abutting edge 28 of the first piece 20 can have a thickness which is inclined in a first direction, while the second abutting edge 38 of the second tubular portion 32 of the second piece 30 can have a thickness which is inclined in an opposite direction to the first, so that in correspondence with the areas of contact and union between the aforementioned two edges 28 and 38 the internal surfaces of the respective tubular portions are substantially flush, thus defining a substantially continuous internal surface which avoids the formation of turbulence in the flow of fluid.

Suitably, therefore, the second piece 30, and in particular its second tubular portion 31, define a receiving section/cavity for the dividing plates 70 which protrude from the first tubular portion 21 of the first piece 20.

Conveniently, the second piece 30 comprises a second opening 35 for the passage of ultrasonic signals 17 emitted and/or received by at least one second ultrasonic sensor 19″ which is mounted (or which is intended to be mounted) on said second piece 30. Conveniently, the second opening is obtained in correspondence with the second upper wall 32′.

Conveniently, once the dividing plates 70 of the first piece 20 are inserted inside the second piece 30 and the first connecting edges 28 of the first piece 20 are in contact with the second connecting edges 38 of the second piece 30, the two sensors 19′ and 19″—mounted respectively on the first piece 20 and on the second piece 30—are placed side by side, one upstream and one downstream, along the direction X in which the fluid F crosses the duct.

Preferably, the second opening 35 is obtained on the second upper wall 32′ of the second tubular portion 31 of the second piece 30 and is configured so that the ultrasonic signals (waves) 17, emitted by at least one corresponding second ultrasonic sensor 19″, enter and/or come out of the measuring channel 40—which is obtained by joining and fixing the second piece 30 to the first piece 20—crossing said opening 35.

Conveniently, at the second opening 35, the second piece 30 comprises a corresponding second mounting portion 34 for the second ultrasonic sensor 19″. Conveniently, the second mounting portion 24 comprises a corresponding second seat 36 which is configured to receive a corresponding ultrasonic sensor 19″. The second seat 36 communicates with the second opening 35 so that the ultrasonic signals 17 can enter the measuring channel 40 and/or leave it.

Conveniently, the longitudinal development axis A′ of the second mounting portion 34 is angled with respect to the direction X by a corresponding angle α′ which is less than or equal to 90°.

Conveniently, the second mounting portion 34—and in particular the second seat 36 for housing the second sensor 19″—is configured so that the ultrasonic signals 17 emitted by the second sensor 19″ enter and leave the channel of measurement 40 at an angle with respect to the direction X, and in particular with respect to the direction of main advancement of the flow F of fluid inside the channel.

Conveniently, the first 20 and/or the second piece 30 can/can also comprise means 51 for connecting the piece itself (and therefore of the conduit 1 resulting from the union of the union of the two pieces) with other components of the meter inside of which the duct 1—and the corresponding device provided with the duct—is intended to be installed. Preferably, these connection means 51 are provided in correspondence with the second mouth 27″ provided in the second piece 30 and comprise, for example, a connection/hooking area provided with elements (for example slots) for the mechanical engagement of corresponding counters—elements of a component (not shown) housed inside the measuring device in which a device provided with duct 1 is also installed.

Conveniently, the second piece 30 can comprise an inclined internal surface 47 in which a reflection zone 46′ is defined for the ultrasonic signals 17 emitted by the sensors 19′ and/or 19″, to thus vary and optimize the reflection angle of the said ultrasonic signals towards the corresponding receiving sensor 19′ and/or 19″. Preferably, this inclined inner surface 47 is defined on the second bottom wall 32″ of the second piece 30.

Preferably, the angle of inclination and the extension of the inclined internal surface 47, in which the reflection zone 46′ is also obtained, are suitably defined on the basis of the angle that the longitudinal development axis A of the housing seat, respectively 26 for the first sensor 19′ and 36 for the second sensor 19″, defined with the X direction.

Preferably, once the second piece 30 is joined and fixed to the first piece 20, the walls of the first tubular portion 21 of the first piece 20 are substantially coplanar or in any case parallel to the respective walls of the second tubular portion 31 of the second piece 30.

Conveniently, in a possible embodiment, the longitudinal development axis A of the first mounting portion 24 for housing the first sensor 19′ defines an angle α with the direction X which can be substantially equal to the angle α′ which the longitudinal development axis A′ of the second mounting portion 34 for housing the second sensor 19″ always defines with respect to the direction X.

Conveniently, in another possible embodiment, the longitudinal development axis A of the first mounting portion 24 for housing the first sensor 19′ defines an angle α with the X direction which can be different from the angle α′ which the longitudinal development axis A′ of the second mounting portion 34 for housing the second sensor 19″ always defines with respect to the X direction.

Preferably, the inclination angle α, with respect to the X direction, of the longitudinal development axis A of the first mounting portion 24 for housing the first sensor 19′ and the inclination angle α′, with respect to the X direction, of the longitudinal development axis A′ of the second mounting portion 34 for housing the second sensor 19″ are suitably determined on the basis of the length of the measuring channel 40 and/or on the basis of the reflection geometry (for example a “V” or “W”) of the ultrasonic signal within the canal itself.

Conveniently, the same first piece 20 can be associated with different second pieces 30, for example having different inclinations and/or surface treatment of the inner surface 47 of the second back wall 32″, thus defining measuring channels 40 of different lengths, as well as reflection paths of different geometries. Conveniently, the same second piece 30 can be associated with different first pieces 20, for example having different lengths of the first tubular portion 21 and/or of the dividing plates 70 and/or having different inclination of the mounting portion 24 for the first sensor 19′, thus defining measuring channels 40 of different lengths, as well as reflection paths of different geometries.

This is particularly advantageous if, for example depending on the type of gas to be measured, one wishes to modify the reflection path of the ultrasonic signals 17, thus passing from a reflection geometry with a single bounce (which defines a “V”) to one with three bounces (which defines a “W” shape), or even more than three bounces, or vice versa, and/or even if you want to lengthen the path of the ultrasonic signals 17 which cross the fluid flow F without intervening on the inclination angle α and/or α′, respectively of the first mounting portion 24 for the first sensor 19′ and of the second mounting portion 34 for the second sensor 19″.

Advantageously, the first piece 20 and the second piece 30 can comprise mechanical engagement means (not shown), preferably mechanical engagement means for hooking (for example clip), for press-fit, for interlocking and/or snap (also called of “snap-fit”), which are configured to hold the two pieces together. Preferably, the mechanical engagement means comprise first means provided on the walls of the first tubular portion 21 of the first piece 20 and which are configured to engage by hooking, interlocking and/or snap with second means provided on the walls of the second tubular portion 31 of the second piece 30.

Preferably, in a possible embodiment (not shown), the first means comprise at least one tongue which is elastically yielding and which has a hole into which a corresponding pin which defines the second means engages by interlocking. Suitably, each tab has a suitable elastic yield so that the contact of its end, preferably blunt, with the pin causes its bending until the pin itself faces the hole, thus allowing the elastic return of the tab and the insertion at fit the pin into the hole. Advantageously, moreover, the pin can be further fixed in the hole of the tab by welding, preferably ultrasonic.

Conveniently, the mechanical engagement means are configured to be activated when the joint movement between the second piece 30 and the first piece 20 reaches corresponding end-of-stroke positions, in particular when the first abutment edge 28 of the first piece 20 comes into contact with the second abutting edge 38 of the second piece 30. Conveniently, the mechanical engagement means allow the two pieces 20 and 30 to be fixed and kept stably joined together over time.

Conveniently, the internal surface 47—preferably inclined—of the second upper wall 32′ and/or of the second bottom wall 32″ of the second piece 30 can comprise at least one groove 45, which extends longitudinally along the X direction, configured to accommodate inside it by means of shape coupling a section of a corresponding dividing plate 70 which emerges from the first tubular portion 21 of the first piece 20.

Conveniently, each groove 45 and each portion of the dividing plate 70 which fits into said groove 45 are configured so as to define an engagement and interlocking of such a shape as to substantially prevent the entry of fluid inside the groove.

Conveniently, the second piece 30 and/or the first piece 20, or in any case the piece in which at least one reflection zone 46′, 46″ and/or 46″′ is defined for the ultrasonic signals 17 emitted by the sensors 19′ and/or 19″, may/may be made exclusively of a thermoplastic material or may/may be made predominantly of a thermoplastic polymeric material and also comprise inserts (as described in greater detail below) in a different polymeric, thermoplastic or not, for example metallic. Preferably, the second piece 30 and/or the first piece 20, or in any case the piece in which the reflection zones for the ultrasonic signals 17 emitted by the sensors 19′ and/or 19″ are defined, may comprise zones with a different surface finish, for example treated so as to make it substantially “mirror-like”, to thus facilitate the reflection of said ultrasonic signals 17.

Advantageously, the reflection zones 46′, 46″ and/or 46″′, in correspondence with which the ultrasonic signals 17 are intended to be reflected, can be made of a different material or with a different surface finish with respect to the remaining part of the second piece 30 and/or with respect to the first piece 20. For example, the reflection zones can be made or treated so as to define a glossy surface. Conveniently, the reflection zones can be made of different materials with respect to the remaining part of the piece made of polymeric material, for example they can be made of metal and preferably co-molded with the piece itself. Conveniently, the reflection zones can comprise with a different conformation with respect to the remaining part of the second piece 30 and/or with respect to the first piece 20. Preferably, the reflection zones can comprise a hollow profile and/or a protruding profile. Preferably, the hollow profile and/or the protruding profile comprise suitably rounded portions and is free from sharp edges. Preferably, the reflection zones can comprise diffraction gratings, for example defined by a plurality of equal pyramids, equidistant and aligned with each other along the X and Z directions.

Conveniently, in a possible embodiment, in correspondence with the second abutting edges 38 of the second piece 30 which come into mutual contact with the first abutting edges 28 of the first piece 20 when these are joined together, gaskets can be provided, preferably rubber or other soft material. Conveniently, in this case, the rubber gaskets are co-molded with the body of the first 20 and/or of the second 30 piece which is made of plastic.

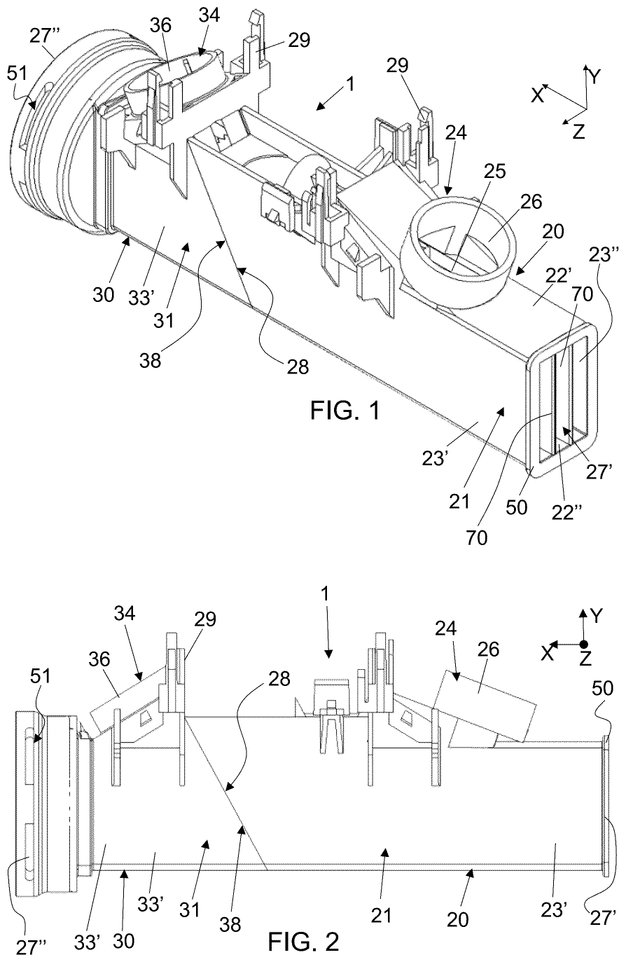

Conveniently, at the first upper wall 22″ of the first piece 20 and at the second upper wall 32″ of the second piece 30 (cf. embodiment of FIG. 1) or only at the first upper wall 22″ of the first piece 20 (cf. embodiment of FIG. 4), the duct 1 can also comprise mounting means 29 of an electronic board provided with a command and control unit (for example microprocessor or microcontroller) for the ultrasonic sensors 19′, 19″ and/or a processing unit (for example microprocessor or microcontroller) of what is detected by the ultrasonic sensors 19′, 19″.

The present invention also relates to an ultrasound device for measuring a fluid, preferably for measuring the flow rate of a gas, which is provided with a duct 1 as described above.

The device also comprises a pair of ultrasonic sensors 19′, 19″ which are respectively arranged one upstream and the other downstream along the longitudinal development direction X of the measuring channel 40 which is defined once the two pieces 20 and 30 of the duct 1 are joined and fixed together. Conveniently, the ultrasonic sensors 19′, 19″ are operatively associated with the duct 1 so as to emit ultrasonic signals 17 within the measurement channel 40 and receive the ultrasonic signals 17 emitted and reflected within said channel.

Conveniently, each ultrasonic sensor is of the traditional type in itself and is configured to emit and receive ultrasonic signals 17.

Conveniently, in the device according to the invention, the first sensor 19′ is mounted in the first mounting portion 24′ of the first piece 20, while the second sensor 19″ is mounted in the second mounting portion 34 of the second piece 30.

Conveniently, the two ultrasonic sensors 19′, 19″ are mounted on the respective pieces 20 and 30 so that the ultrasonic signals 17 are emitted and received diagonally with respect to the longitudinal development direction X of the measuring channel 40 and diagonally with respect to the direction of main advancement of the fluid inside said channel.

The device also comprises a unit for measuring the flow rate and/or flow of the fluid which passes through the channel 40 of the conduit 1 of the device itself. In particular, the measurement unit is configured to calculate the flow rate on the basis of the propagation time of the ultrasonic signals 17 between the two sensors 19′, 19″, in particular from the upstream sensor 19′ to the downstream one 19″, and/or vice versa. In particular, the propagation time is the period of time which elapses between the instant in which a sensor 19′, 19″ emits an ultrasonic signal 17 so as to make it propagate through the fluid to be measured up to the instant in which said ultrasonic signal 17 is received by the other sensor 19′, 19″. Conveniently, the configuration of the flow rate or flow measurement unit is obtained, in a manner per se known to those skilled in the art and therefore not described in detail below, on the basis of the propagation time.

Conveniently, said flow rate measurement unit comprises a microprocessor or microcontroller mounted on an electronic card which is electronically connected to the pair of ultrasonic sensors 19′, 19″.

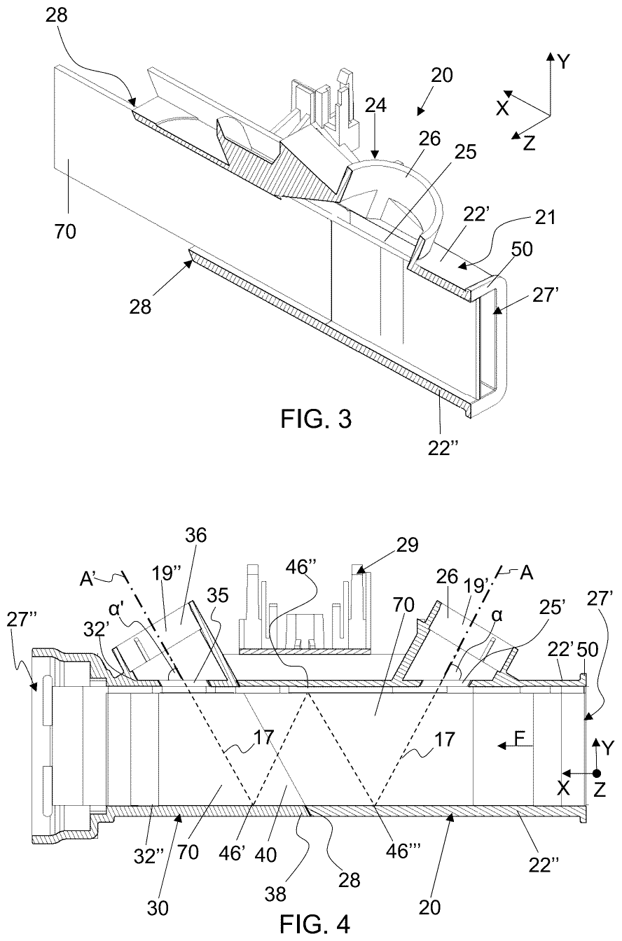

Conveniently, in a further embodiment (cf. FIGS. 5 and 7), the ultrasonic signals 17 emitted by a sensor 19′ or 19″ are reflected—in correspondence with a reflection zone 46′ defined on the inner surface of the second piece 20 and/or of the first piece 30—towards the other sensor 19″ or 19′, to thus define a substantially “V”-shaped reflection path of the ultrasonic signals 17, or—in a further embodiment (cf. FIG. 3)—are also reflected in further reflection zones 46″ and 46″′ obtained or defined respectively in correspondence with the first upper wall 22′ and the first bottom wall 22″ of the first piece 20, thus defining a substantially “W” reflection path of the ultrasonic signals 17.

Conveniently, it is understood that the conduit 1 can have any shape, not necessarily tubular as shown in the figures, thus generically meaning any structure, of any shape and size, which is crossed by a fluid entering at a first mouth and exits at a second mouth, or vice versa. Conveniently, for example, the duct 1 can comprise, upstream and/or downstream of the measuring channel, a portion shaped like a tank or a chamber, variously shaped, as well as a further tubular section. Conveniently, the duct 1 can consist only of the two pieces 20 and 30 (as shown in the figures), but could also comprise further pieces (not shown here). Conveniently, the first piece 20 can consist only of the tubular portion 21 (as illustrated in the figures), but could also comprise further variously shaped portions (not shown here). Conveniently, the second piece 30 can consist only of the tubular portion 31 (as illustrated in the figures), but could also comprise further variously shaped portions (not shown here).

From what has been said it is clear that the duct and the device according to the invention are particularly advantageous because:
has a high modularity, in particular allowing to easily vary and optimize the reflection characteristics of the ultrasonic signals that are emitted inside the duct,
it is possible to combine and join the same second piece with several first pieces, or even vice versa, which are different from each other in terms of length of the tubular portion, inclination and/or position of the housing seat for the sensors, thus allowing to define channels of measurement of different lengths and different and optimized reflection paths according to the composition of the medium to be measured (for example in natural gases or hydrogen),
the second piece—which is made/molded separately from the first piece—can be made, at least in correspondence with the reflection surface, of a suitable and dedicated shape, material and/or surface finish, and this in order to improve the focusing of the signals ultrasonic waves (for example creating a lens effect) towards the receiving sensor, thus compensating the sensor tolerance, and/or in order to attenuate or eliminate non-collimated ultrasonic signals (i.e. those out of phase or incident in an area too upstream or too far downstream), thus improving the signal-to-noise ratio,
it can be made and assembled in a simple, rapid and low-cost way,
it is structurally and functionally entirely reliable, and
it is an improvement and/or alternative to traditional solutions.

In particular, advantageously, the fact that the measuring channel 40 is obtained by joining two pieces 20, 30—each of which is provided with a corresponding tubular portion 21, 31—allows to obtain more or less long measuring channels, depending on the fluid whose characteristics and in particular the flow rate are to be measured, and this can be done easily and simply by selecting a different and suitable second piece 30 to be associated with the same first piece 20, or vice versa.

The present invention has been illustrated and described in a preferred embodiment thereof, but it is understood that executive variants can be applied to it in practice, without however departing from the scope of protection of the present patent for industrial invention.

1. Duct, for the passage of a fluid to be at least one of: detected or measured, said duct being suitable for being used for or in an ultrasound device for measuring the fluid, the duct comprising:
a first piece and a second piece, which are entirely or mostly made of polymeric material by molding, and which, once molded, are configured to be joined and fixed together to define, following their union, a measuring channel, which is configured to be crossed by the fluid to be measured,
said first piece comprises:
a first port for the inlet or outlet of the fluid to be measured in or from said conduit,
a first opening, obtained in said first piece, for the passage of ultrasonic signals, which are at least one of: emitted or received by at least one first ultrasonic sensor configured to be mounted on said first piece,
a first tubular portion which is provided with a first abutment edge,
said second piece comprises:
a second port for the outlet or entry of the fluid from or into said duct,
a second opening, obtained in said second piece, for the passage of ultrasonic signals, which are at least one of emitted or received by at least one second ultrasonic sensor configured to be mounted on said second piece,
a second tubular portion which is provided with a second abutment edge,
said first piece and said second piece are configured in such a way that said first abutment edge of the first tubular portion of the first piece comes into contact with the second edge abutment of the second tubular portion of the second piece, to thus define said measuring channel.

2. The duct according to claim 1, further comprising:
at least one dividing plate protruding from said first tubular portion for the flow of fluid which is configured to cross said measuring channel,
said first piece and said second piece are configured in such a way that, when the first abutting edge of the first tubular portion of the first piece comes into contact with the second abutting edge of the second tubular portion of the second piece to thus define said measuring channel, said at least one dividing plate protruding from the first tubular portion of the first piece is entirely inserted and housed inside said second tubular portion of the second piece.

3. The duct according to claim 2, wherein said at least one dividing plate is formed in a single body/piece with said first tubular portion.

4. The duct according to claim 1, wherein said first tubular portion of the first piece has a substantially rectangular cross section and said second tubular portion of the second piece has a substantially rectangular cross section.

5. The duct according to claim 1, wherein:
said first piece comprises, in correspondence with the first opening, a first mounting portion for a first sensor, said first mounting portion being angled with respect to the longitudinal development direction X of the first tubular portion of the first piece,
said second piece comprises, in correspondence with the second opening, a second mounting portion for a second sensor, said second mounting portion being angled with respect to the development direction longitudinal X of the second tubular portion of the second piece.

6. The duct according to the claim 5, wherein the longitudinal development axis A of the first assembly portion is angled with respect to the longitudinal development direction X of the first tubular portion so that the ultrasonic signal emitted by the first sensor defines a reflection path in a V-configuration, symmetrical or asymmetrical, or in a W-configuration, to then be received by the second sensor mounted on the second piece, or vice-versa.

7. The duct according to claim 5, wherein
the longitudinal development axis A of the first mounting portion is angled with respect to the longitudinal development direction X of the first tubular portion by an angle α,
the longitudinal development axis A′ of the second mounting portion is angled with respect to the longitudinal development direction X of the second tubular portion by an angle α′,
and in which the angles α and α′ are substantially equal to each other.

8. The duct according to claim 5, wherein
the longitudinal development axis A of the first mounting portion is angled with respect to the longitudinal development direction X of the first tubular portion by an angle α,
the longitudinal development axis A′ of the second mounting portion is angled with respect to the longitudinal development direction X of the second tubular portion by an angle α′,
and wherein the angles α and α′ are different from each other.

9. The duct according to claim 1, wherein said second tubular portion comprises:
a second upper wall on which said second opening is formed,
a second bottom wall which faces said second upper wall,
and wherein at least one reflection zone is formed in said second bottom wall.

10. The duct according to claim 1, wherein said second bottom wall is at least one of: inclined with respect to the longitudinal development direction X of the second tubular portion of the second piece; is made, at least in part, of a different material; or is made, at least in part, with a different surface finish than the remaining part of the second piece.

11. The duct according to claim 1, wherein said first tubular portion comprises:
a first upper wall on which said first opening is formed,
a first bottom wall which faces said first upper wall,
and wherein at least one reflection zone is formed in at least one of said first upper wall or in said first bottom wall.

12. The duct according to claim 1, wherein said first piece and the second piece comprise mechanical engagement means: for hooking, for press-fit, for interlocking, or snap-fit, configured to keep said first piece and said second piece joined together.

13. The duct according to claim 12, wherein said mechanical engagement means are configured to be activated when the joint movement between the second piece and the first piece reaches corresponding end-of-stroke positions, when the first abutting edge of the first piece contacts the second abutting edge of the second piece.

14. The duct according to claim 1, wherein at least one of said first piece or said second piece comprise means for connecting the piece itself, and therefore of the duct resulting from the union of the two pieces, with other components.

15. The duct according to claim 1, wherein the measuring channel is closed in a fluid-tight manner at least in correspondence with the areas of union or contact between said first piece and said second piece.

16. The duct according to claim 1, wherein at least one of said first piece or said second piece are fixed and kept together, at the respective abutting edges by at least one of the following technologies for joining plastic materials: gluing, welding, hot plastic riveting or mechanical joining.

17. The duct according to claim 1, wherein said at least one dividing plate has a development along the longitudinal development direction X of the first tubular portion of the first piece such that, when the first abutting edge of the first piece comes into contact with the second abutting edge of the second piece, said at least one dividing plate substantially affects most or all longitudinal development along the X direction of the measuring channel.

18. The duct according to claim 1, wherein at least one of the first piece or the second piece comprises an inclined internal surface defining a reflection zone of the ultrasonic signals emitted by the sensors, to thus vary and optimize an angle of reflection of the ultrasonic signals towards the corresponding receiving sensor.

19. The duct according to claim 11, wherein said at least one reflection zone for the ultrasonic signals is made of at least one of: a different material or with a different surface finish compared to the remaining part of the second piece or the first piece.

20. The duct according to claim 1, further comprising:
at least one dividing plate protruding from said second tubular portion for the flow of fluid which is intended to cross said measuring channel, said at least one dividing plate protruding from said second tubular portion is formed in a single body/piece with said second tubular portion,
said first piece and said second piece are configured in such a way that, when the first abutting edge of the first tubular portion of the first piece comes into contact with the second abutting edge of the second tubular portion of the second piece to thus define said measuring channel, said at least one dividing plate protruding from the second tubular portion of the second piece is fully inserted and housed inside said first tubular portion of the first piece.

21-22. (canceled)
